(19) United States
(12) Patent Application Publication
(10) Pub. No.: US 2019/0289243 A1
(43) Pub. Date: Sep. 19, 2019

(54) SIGNAL COMMAND TRANSLATION

(71) Applicant: Elite Yacht Solutions, LLC, Cocoa, FL (US)

(72) Inventors: Donald Pretlow, Cocoa, FL (US); Lee Bennett, Merritt Island, FL (US); Michael Reischmann, Eustis, FL (US)

(21) Appl. No.: 15/922,531

(22) Filed: Mar. 15, 2018

(51) Int. Cl. H04N 5/44; G08C 17/02; G08C 23/04

(52) U.S. Cl. CPC H04N 5/4403; H04N 2005/4426; G08C 23/04; G08C 17/02

(57) ABSTRACT

As may be implemented in accordance with one or more embodiments, methods and/or apparatuses involve translating control signals between remote input devices and endpoint devices that are to be controlled. Received control commands are selectively translated based on an endpoint device to be controlled, and an output signal is provided for controlling the endpoint device in accordance with the received control commands. This approach facilitates the use of an input device for controlling an endpoint device, without necessarily requiring that the input device is configured to provide control signals that the endpoint device can operate upon.

### BACKGROUND

Many signaling applications involve sending commands from a transmitter to a receiver that is integrated with or otherwise communicatively coupled to one or more endpoint devices, for controlling such endpoint devices with the commands. Such applications may involve, for example, controlling a television or other audio/visual (A/V) device with a remote control that transmits commands that the television or A/V device is configured to respond to. To effect such communications, various signaling characteristics, protocols, commands, data formats, and interaction sequences/methods are utilized by disparate devices and their manufacturers. Various wired and wireless communication channels may be used, and may involve one or more of radio-frequency (RF) signals, infrared (IR) signals, wireless local area networking (LAN) signals, Wi-Fi signals, Bluetooth signals, high-definition multimedia interface (HDMI) signals, and near-field communications (NFC).

Remote control of various devices has been very useful for a variety of applications. However, control methods are inconsistent among various manufacturers and among different fields of use. For instance, different manufacturers often utilize different types of signals for similar devices. Further, controls for different fields such as A/V systems and home/vehicle lighting or heating, ventilating and air conditioning (HVAC) control systems often involve very different communication approaches. For systems utilizing a variety of endpoint devices, multiple different remote controls may be required to control each device. Where a centralized remote control (e.g., a universal remote controller) may be programmed to control disparate devices, doing so often requires expensive controllers, relay circuits, and complex setup.

These and other matters have presented challenges to controlling endpoint devices for a variety of applications.

### SUMMARY

Various example embodiments are directed to translating signal commands, such as may be implemented for utilizing a plurality of disparate input control signal transmitters, with a plurality of disparate endpoint devices that use different signaling and/or control characteristics.

In accordance with one or more aspects, methods and/or apparatuses involve translating control signals between remote input devices and endpoint devices that are to be controlled. Received control commands are translated based on an endpoint device to be controlled, and an output signal is provided for controlling the endpoint device in accordance with the received control commands. In this context, translating received control commands may involve assessing a type of command intended to be carried out via the received control command, and transmitting an output command that will cause a particular endpoint device to carry out the intended commend. For instance, received control commands can be parsed with stored control commands to identify the intended command, and an output command that matches the intended command and that is operable for controlling a particular endpoint device can be retrieved and transmitted to the endpoint device. This approach facilitates the use of an input device for controlling an endpoint device, without necessarily requiring that the input device is configured to provide control signals that the endpoint device can operate upon. As such, a single remote can be used to control multiple endpoint devices, and multiple remotes can be used to control a single endpoint device, even where the remote and endpoint device do not otherwise communicate. In certain instances where the received command is operable for controlling the endpoint device, the command can be effectively passed through.

In a more particular embodiments, an apparatus includes communication circuitry, logic circuitry and output circuitry, which may be implemented for translating command signals. The communication circuitry is configured and arranged for receiving wireless communications from a plurality of disparate remote input devices. Such wireless communications may include disparate control commands that are specific to each remote input device. The logic circuitry is configured and arranged to translate such disparate control commands received from different ones of the remote input devices into output control commands as follows, for each received control command. An endpoint device that is to be controlled with the received control command is identified. The received control command is then translated into an output control command for controlling the identified endpoint device. The output circuitry is configured and arranged to control the endpoint device for carrying out an operation specified via the received control command, by communicating the output control command to the endpoint device.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description and in connection with the accompanying drawings, in which:

FIG. 1 shows a data flow diagram, in accordance with various embodiments;

FIG. 2 shows an apparatus for translating input control signals into disparate output control signals, in accordance with one or more embodiments;

FIG. 3 shows a data flow diagram for translating functions, in accordance with one or more embodiments;

FIG. 4 shows a data flow diagram for processing a designated type of input command from disparate input devices for establishing a designated function or functions, in accordance with one or more embodiments;

FIG. 5 shows a menu-based approach for translating commands for controlling specific endpoint devices, in accordance with one or more embodiments;

FIG. 6 shows a software stack for implementation with translating command signals, in accordance with one or more embodiments;

FIG. 7 shows an apparatus for translating functions and displaying content utilizing HDMI signals, in accordance with one or more embodiments;

FIG. 8 shows another apparatus for translating functions and displaying content utilizing HDMI signals, in accordance with one or more embodiments; and

FIG. 9 shows another apparatus for translating functions and displaying content utilizing HDMI signals, in accordance with one or more embodiments.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of apparatuses, systems and methods involving translation of control commands for effecting control of one or more devices with the command, where those devices utilize a different communication/signaling for effecting the commands. Such an approach may involve, for example, controlling an endpoint device with a control command transmitter that utilizes control commands that are different than those control commands that the endpoint device responds to. In certain implementations, an input control command for effecting a particular function is translated into an output control command for effecting the same function but using a different type of signaling tailored for an endpoint device. Such approaches may, for example, facilitate the use of a plurality of disparate types of remote control devices for controlling endpoint devices such as televisions, audio devices and other A/V devices, as well as a myriad of electronics that operate on such received commands (e.g., lighting control, navigational control, heating or air conditioning controls, and other mechanical or electro-mechanical controls).

According to various example embodiments, aspects of the present disclosure are directed to utilizing disparate remote controls, such as IR or RF remote controls, to control and automate A/V systems including disparate endpoint devices. Input control signals from the remote controls are translated into output control signals that are suited for controlling one or more of the endpoint devices.

In a particular embodiment, a signal distribution circuit (e.g., for distributing IR, RF or other signal types) utilizes a logic circuit, such as a Linux based computer. The signal distribution circuit receives input commands, such as IR or RF commands from remote controls, and uses logic to control endpoint devices based on the received commands. In this context, one or more output signals are distributed to one or more endpoint devices, based on received input signals.

In some implementations, a display such as a television screen is utilized as a user interface (UI) for determining which endpoint devices are to be controlled. For instance, if a system includes a video monitor (or television), a satellite television receiver, a streaming media player, and a lighting system controller, an icon or other representation of these components can be displayed on the video monitor when a remote control sends a signal. The remote control can then be used to identify which of the components is to be controlled, such as by using arrow left/right or up/down keys on the remote control. Once an endpoint device is selected, further control signals from the remote are translated into signals that can be used to control the selected endpoint device. For instance, if a remote control specific to the video monitor is used to select the satellite television receiver, the logic circuit then translates further commands received from the video monitor remote into different output commands for which the satellite television receiver is configured to respond. Such an approach may involve, for example, identifying the type of remote control that sends the input signals, mapping the received signals to a known function (e.g., changing a channel, pausing or playing video), mapping that known function onto an output signal specific to the satellite receiver, and then outputting the output signal for controlling the satellite receiver.

Accordingly, any remote can be used for controlling the connected endpoint devices. Logic, macros, or other data can be used in an output signal that is tailored to a selected endpoint device, based on incoming signals from any one of a multitude of remote control input devices. In specific instances where an input remote controller specific to the selected endpoint device is used, translation of the signals can be overridden and the received signals can be passed directly to the endpoint device.

In some embodiments, multiple endpoint devices are controlled by logic circuitry to effect a desired function, with received signals from any one of a number of remote input devices being translated according to each device to be controlled, and with disparate signals being communicated to each device based on the input. For instance, where a selected endpoint device is a television, and where the selected function is to watch satellite television, any remote input device can be used to select the television as the endpoint device. An input signal received from the remote input device is processed and used to identify which endpoint devices are to be utilized. For the satellite television example, a user's system may be set up to use a satellite receiver for receiving and selecting a channel, a television for displaying video, and an audio device for playing sound. A remote input device for any one of those three devices, or for another device not being used, can be used to select the function and control all endpoint devices. At initiation of the function of watching satellite television, the television, satellite receiver and audio playback device are all placed in an on state (e.g., turned on or left in an on state if already on). Further inputs from the remote input device are translated to a variety of functions, such as to adjust the television (e.g., brightness), change the channel on the satellite receiver, or adjust volume on the audio device. Such a remote input device need not be programmed for controlling each endpoint device (or any of the endpoint devices); the logic circuitry generates commands for each endpoint device based on the type of remote input device and mapped signals therefrom.

Consistent with one or more embodiments, two modes of operation are provided for controlling endpoint devices in a system, respectively denoted as a device mode and a hub mode, using a plurality of disparate remote input devices. In the device mode, when a signal is received from a remote input device, translating circuitry identifies the type of remote input device and a corresponding endpoint device that matches the identified remote input device (e.g., a remote control provided with a television). Commands received from the remote input device can be used for controlling the endpoint device, as communicated directly between the two devices, by passing received commands through to the endpoint device, or by transmitting a matching command.

Where other endpoint devices work in connection with the controlled endpoint device for carrying out a particular operation selected in device mode, those other devices can be controlled, based on the signals received from the remote input device. For instance, where an operation involves watching television and signals from a remote control that is designed for use with the television are detected, those signals can be translated and provided to other devices that operate in connection with watching television. Such an approach may, for example, involve turning on a satellite TV receiver and/or an audio device, dimming lights, drawing shades, or other functions carried out for watching television. Using this example, a remote input device for the satellite TV receiver can be used in a similar manner in which signals from the remote input device can be used for directly controlling the satellite TV receiver and are also translated for operating the television accordingly (and an audio device if used). As such, a remote input device for any one of the endpoint devices can be utilized to carry out the same operation/activity.

In the hub mode, an input received from any remote input device is utilized to initiate selection of an activity or device. The input can be a common type of input such as a power button, or any input that is received. A centralized logic circuit provides for selection of an activity or endpoint device via received inputs, such as by providing a display of available activities and/or devices, and for selection of one of the displayed activities or devices from the remote input device. Once the activity or endpoint device is selected, signals from the remote input device are selectively translated for carrying out intended commands. This may involve, for example, translating received commands into a command that a selected endpoint device or devices can use. Different remote input devices can also then be used to control the selected endpoint device, with received input commands being selectively translated.

Various embodiments are directed to an apparatus and/or system comprising communication circuitry, logic circuitry and output circuitry, with particular embodiments including one or more of these aspects. The communication circuitry may receive wireless communications from a plurality of disparate remote input devices, such as from hand-held remote control devices that are designed to work with a specific endpoint device. The wireless communications generally include disparate control commands that are specific to each remote input device (e.g., and intended for a particular endpoint device to be controlled). The logic circuitry translates the disparate control commands received from different ones of the remote input devices into output control commands for an identified endpoint device, or multiple endpoint devices to be used in conjunction with one another and/or in separate environments. Specifically, for each received control command, an endpoint device that is to be controlled with the received control command is identified, and the received control command is selectively translated into an output control command for controlling the identified endpoint device. The endpoint device may be identified via the incoming control command and/or stored reference data, or in response to a user selection specifying the endpoint device. The output circuitry facilitates control of the endpoint device for carrying out an operation specified via the received control command, by communicating the output control command to the endpoint device.

The componentry characterized above may be implemented in a variety of manners. For instance, a central device may include the respective circuit components, such as an infrared receiver and related circuitry for receiving and making infrared signals available for processing. The logic circuitry may be implemented as a microprocessor that accesses received signals and stored data for effecting the identification and translation. The output circuitry may include an infrared transmitter, which operates to transmit the output control command by transmitting a signal to the identified endpoint device or devices.

In this context, selective translation may involve, for example, translating the control command for controlling the identified endpoint device for which the received control command is not intended to control, or passing through/replicating the control command when that command is capable of operating the identified endpoint device. Such translation may be based on the operation specified via the received control command and the identified type of specific endpoint device. For instance, the logic circuitry may be implemented to operate in a device mode and provide the received control command as the output control command, in response to the received control command being a command that the identified type of specific endpoint device is configured to operate in response to. If the received control command is a command that the identified type of specific endpoint device is not configured to operate in response to, the logic circuitry may operate in a hub mode in which the received control command is translated into the output command, in which the output command is different than the received control command and configured for controlling the identified type of specific endpoint device to carry out the specified operation.

The logic circuitry may, for example operate to assess characteristics of the endpoint device to be controlled. If the logic circuitry determines that the identified endpoint device is configured to operate in response to the received control command, the received control command can be provided as the output control command. Further, the received control command may be matched to one of a plurality of endpoint devices available for control via the output circuitry, and output to the matched one of the plurality of endpoint devices.

In hub mode, the logic circuitry may selectively translate the received control command into the output control command by identifying an operation intended to be effected via the control command, based on data in the received control command. A different control command that is operable for controlling the identified endpoint device is then selected to carry out the identified operation, based on the identified operation intended to be effected. The selected control command is then provided as the output control command. The logic circuitry may identify the operation intended to be effected via the control command by identifying the type of the remote input device transmitting the received control signal, and by retrieving stored data characterizing operations associated with known control commands communicated by the identified type of the remote input device.

In addition to an identified endpoint device, related devices may also be controlled in accordance with received commands. In some embodiments, the logic circuitry determines whether the identified endpoint device is configured to operate in response to the received control command. If the identified endpoint device is configured to operate in response to the received control command, an ancillary endpoint device, which is to be used with the identified endpoint device for a particular activity, is also identified along with a control command for controlling the ancillary endpoint device to operate in conjunction with the identified endpoint device for carrying out the operation. The identified control command is then transmitted to the ancillary endpoint device.

An endpoint device or activity may be selected in a variety of manners. In some embodiments, a common type of command button is used in this regard, such as to provide access to a menu function or device selection function. In some embodiments, the logic circuitry responds to a common command type (e.g., a power button) received from any of the plurality of disparate types of remote input devices by entering into a device selection mode. In the device selection mode, the endpoint device to be controlled is identified in response to a further input from one of the plurality of disparate types of remote input devices.

Endpoint devices and/or commands can be assessed in a variety of manners. In some embodiments, the logic circuitry identifies the operation specified via the received control command by comparing the received control command with stored commands. The operation is then identified based on stored data that associates one of the stored commands that matches the received control command with an operation. Storage circuitry (e.g., local memory) may be used to store a plurality of operations, and to associate each stored operation with multiple ones of the stored commands that respectively correspond to control commands for disparate ones of the remote input devices.

Endpoint devices can be identified in a variety of manners. In some embodiments, the logic circuitry identifies the endpoint device to be controlled based on data indicative of endpoint devices available for control by the output circuitry, and characteristics of the received control command. In other embodiments, the logic circuitry automatically selects an available endpoint device to control based on the location of the received control command and of devices pertaining to command. For instance, one of at least two endpoint devices available for control via the output circuitry may be selected based upon a location at which the control command is received and respective locations of the at least two endpoint devices. In certain embodiments, an endpoint device is automatically selected (e.g., via a user interface on TV screen) via learning approaches. For instance, the endpoint device to be controlled can be identified based on communications received from one or more endpoint devices communicatively coupled to the logic circuitry. In further embodiments, available endpoint devices are discovered based on communications from the available endpoint devices themselves (e.g., responding to a wake-up signal or polling signal requesting identification). In a more direct approach, the control command may include information explicitly identifying the endpoint device to be controlled.

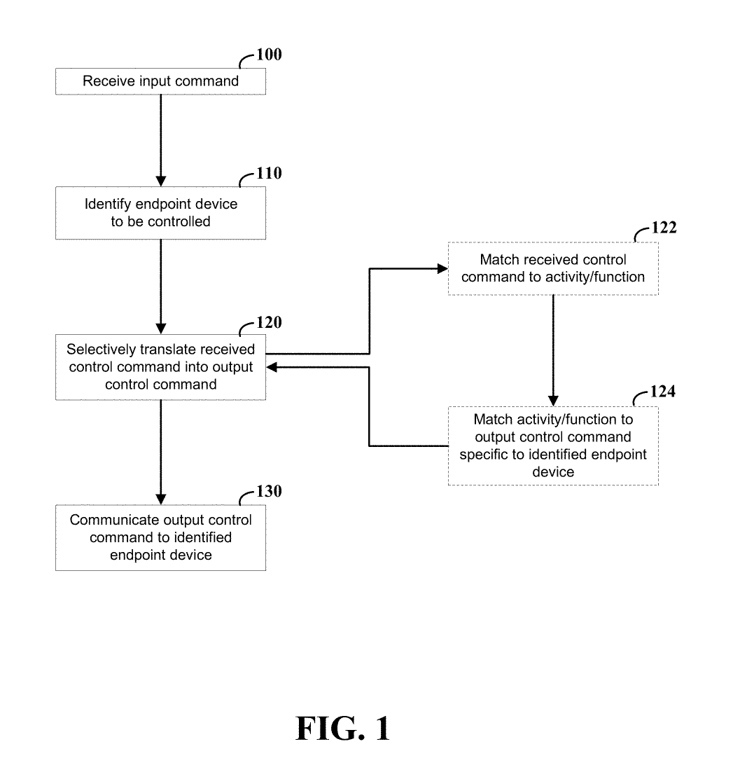

Turning now to the figures, FIG. 1 shows a data flow diagram as may be implemented in accordance with various embodiments. At block 100, an input command is received, and an endpoint device to be controlled is identified at block 110. A received control command is selectively translated at block 120, and an output control command is communicated at block 130, for controlling an endpoint device.

The selective translation at block 120 can be carried out in a variety of manners, such as described herein. In some embodiments, the received control command is matched to an activity or function at block 122. This matched activity or function is then used to identify an output control command at block 124, which is specific to a particular endpoint device to be controlled. The matched activity may, for example, be for an ancillary endpoint device that is used in conjunction with an endpoint device being utilized (e.g., a media player that provides media to a monitor, where the selected activity involves watching the monitor). Further, these approaches may be carried out in a device mode or hub mode as characterized herein.

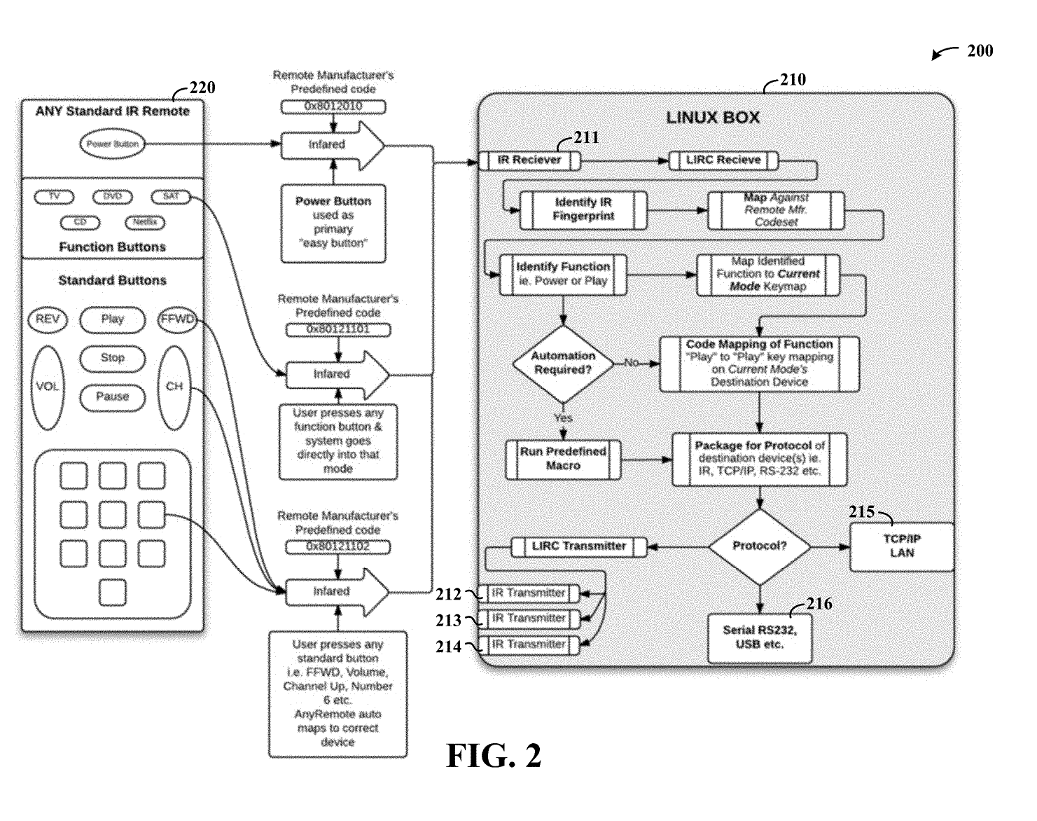

FIG. 2 shows an apparatus 200 for translating input control signals into disparate output control signals, in accordance with one or more embodiments. The apparatus 200 is shown with logic circuitry 210 that interacts with a plurality of remote input devices, with remote 220 shown by way of example. The logic circuitry 210 (e.g., Linux-based) includes a receiver 211, transmitters 212, 213 and 214, a TCP/IP LAN interface 215, and a further interface 216 as may be implemented with one or more of RS232 and USB communications. Signals received from the remote 220 on the receiver 211 are processed and used to generate output signals that are transmitted on one or more of transmitters 212, 213 and 214 for controlling one or more respective endpoint devices.

The logic circuitry 210 may operate in accordance with one or more embodiments herein for controlling such endpoint devices. In some embodiments, the logic circuitry 210 operates in accordance with data-flow steps shown in FIG. 2. Received infrared signals are parsed to identify an IR fingerprint, which is mapped against a remote manufacturer code set to identify a function intended by each signal. The identified function is then mapped in accordance with a current mode, such as to match an input “play” command to an output “play” command for an endpoint device that may not be amenable to control with the input “play” command. The mapped function is then packaged for a protocol of the endpoint (destination) device to be controlled. If automation is required, a predefined macro is run. Depending on the protocol, a signal is output via one or more of the IR transmitters 212-214, the TCP/IP LAN interface 215 and interface 216.

The aforementioned approach may be carried out using a variety of remote input signals. By way of example, a power button signal may be implemented for a primary “easy button” in which the logic circuitry 210 responds by going into a device or activity selection mode. Once the remote 220 is identified, respective buttons pressed on the remote are processed in accordance with that remote's intended function. For instance, when the “SAT” (satellite) button is pressed, the logic circuitry 210 responds by identifying the received code as being for the satellite function and places one or more respective endpoint devices into the satellite mode, such as by turning on a satellite receiver and a television to display programming received via the satellite. Once the function is set, further buttons such as to control volume, change or select a channel, pause or play, and others are processed to identify the code accordingly, such as to turn volume up on the television or an audio device used with the television, or change a channel on a satellite receiver.

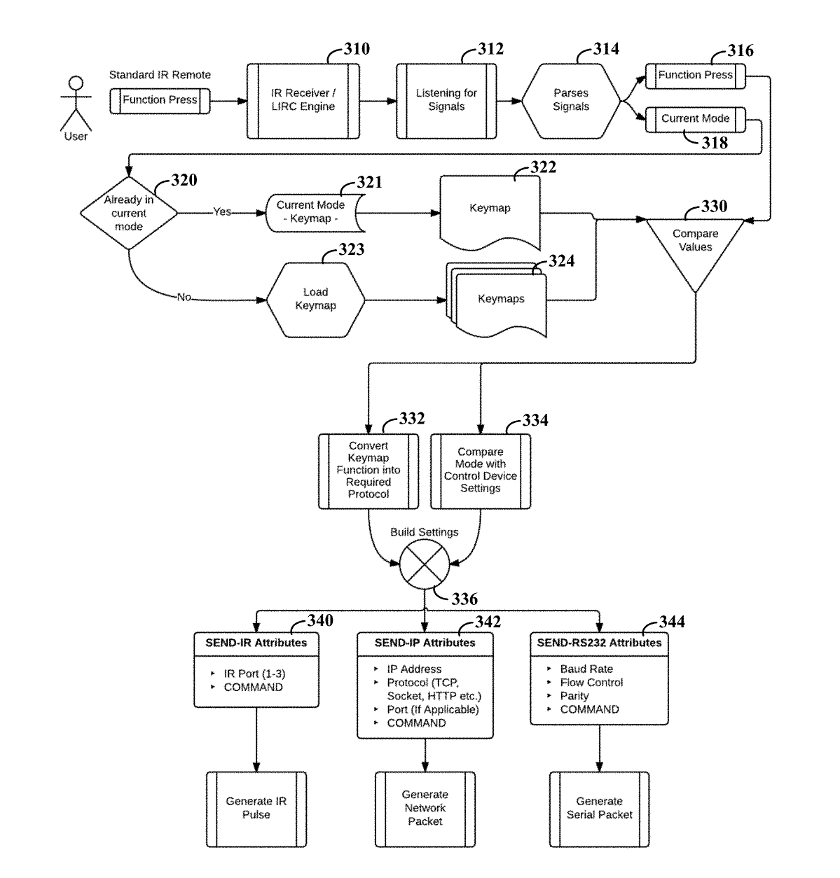

FIG. 3 shows a data flow diagram for translating functions, as may be implemented in accordance with one or more embodiments. The approach shown in FIG. 3 may, for example, be implemented with the apparatus shown in FIG. 2. A receiver at 310 is used for listening for signals at block 312, with received signals being parsed at block 314 for identifying the signals as indicating a function and/or mode of operation. Where a received signal indicates a mode of operation as noted in block 318, if a current mode matches the indicated mode at 320, the current mode keymap is identified at block 321 and provided at block 322. If the indicated mode of operation at block 318 is not the current mode at 320, one or more keymaps are loaded at 323 and provided at 324.

When a received signal involves a function press (e.g., “play” or “volume up”) as noted at block 316, the value of the function press is compared at 330 to a value in one of the provided keymaps at 322 or 324 to identify a function to carry out. At block 332, the identified function is converted to a required protocol for controlling one or more desired endpoint devices for carrying out the function. At block 334, the mode is compared with control device settings, and combined with the converted function for building settings at 336 for one or more endpoint devices. Such settings may involve, for example, utilizing infrared communications at block 340, IP communications at block 342, or RS 232 communications at block 344.

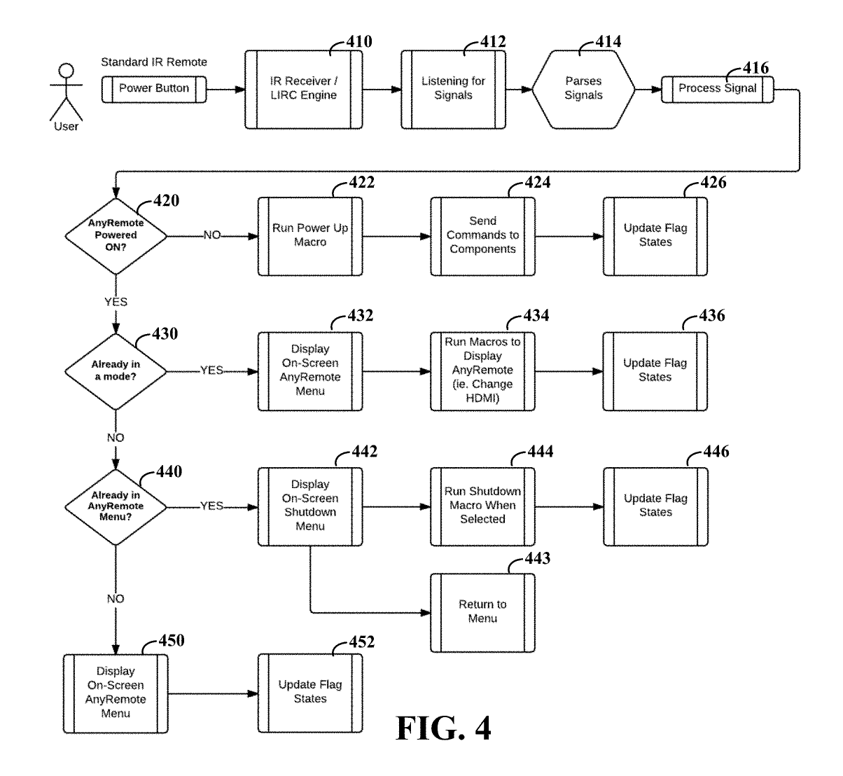

FIG. 4 shows a data flow diagram for processing a designated type of input command from disparate input devices, for establishing a designated function or functions in accordance with one or more embodiments. The approach shown in FIG. 4, may, for example, be implemented with the apparatus shown in FIG. 2. A receiver at 410 is used for listening for signals at block 412, with received signals being parsed at block 414 for providing a process signal at 416. If logic circuitry for effecting control of endpoint devices is not powered at 420, a power up macro is run at block 422, commands are sent to components for powering on at block 424, and flag states are updated at block 426. If the logic circuitry is in a current mode at 430, an on-screen menu is displayed at block 432, macros are run to display available operations at block 434, and flag states are updated at block 436. Once in a mode, if an appropriate menu is displayed at 440, a shutdown menu is displayed at block 442 and a shutdown macro is run at block 444 if shutdown is selected, with flag states being updated accordingly at block 446. If shutdown is not selected, the display is returned to a main menu at block 443. If the logic circuitry is not in a current menu at 440, a menu for the particular mode is displayed at block 450 and flag states are updated at block 452.

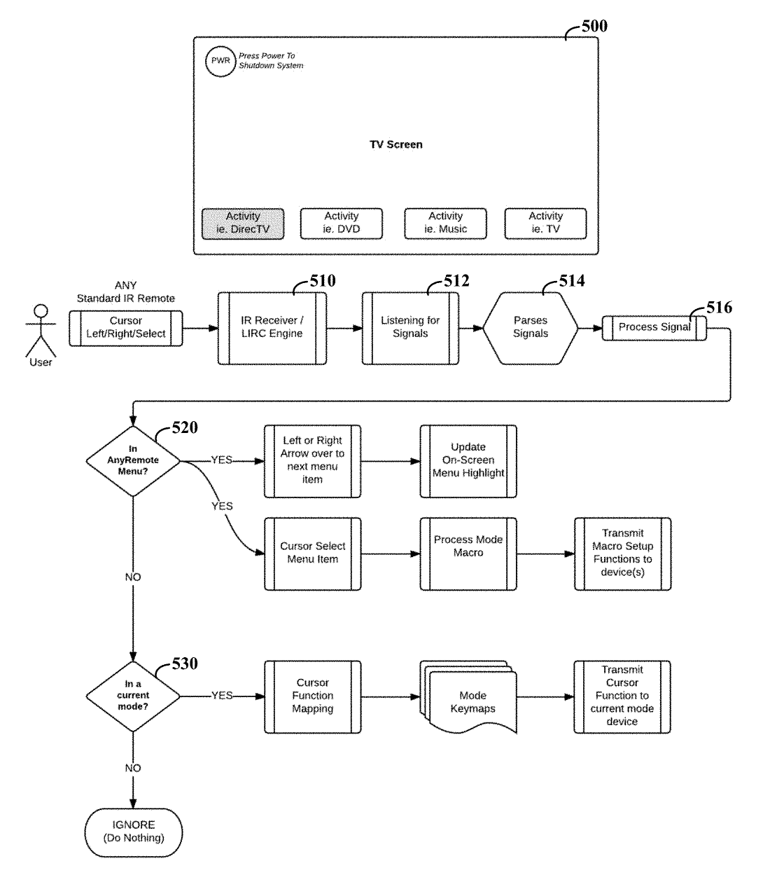

FIG. 5 shows a menu-based approach for translating commands for controlling specific endpoint devices with logic circuitry, in accordance with one or more embodiments. The approach shown with FIG. 5 may be used with those shown in and with FIGS. 2-4. A monitor such as a TV screen 500 is used to display menus as follows. A receiver at 510 is used for listening for signals at block 512, with received signals being parsed at block 514 for providing a process signal at 516. If the monitor 500 is showing the menu, the process signal 516 is used for accessing the current menu, such as arrowing left or right (with the menu being highlighted), selecting a function, processing a mode macro (e.g., for watching satellite TV), and transmitting macro setup functions to devices for a particular activity. If the menu is not displayed and the logic circuitry is in a current mode at 530, the process signal is used with the mode, such by cursor function mapping in accordance with keymaps, with the cursor function being transmitted to a device utilized in the current mode. If the logic circuitry is not in a current mode at 530, the process signal can be ignored.

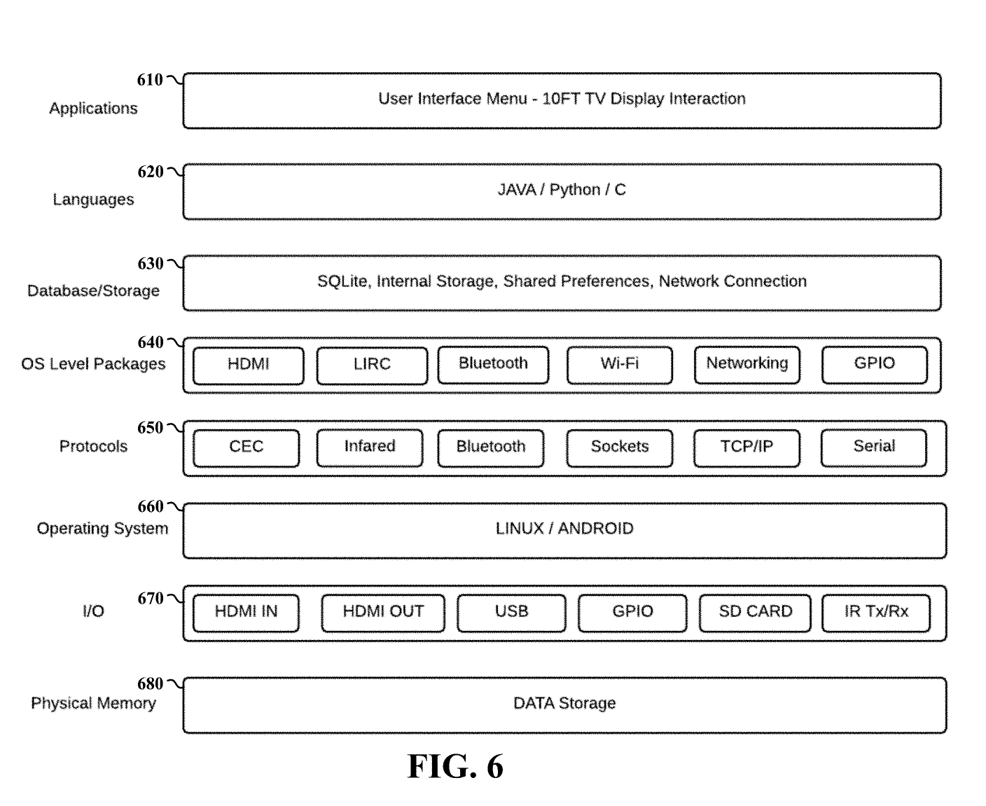

FIG. 6 shows a software stack for implementation with translating command signals, in accordance with one or more embodiments. The stack includes an application layer 610, language layer 620, database/storage layer 630, OS level packaging layer 640 and protocol layer 650. The stack also includes an operating system layer 660, input/output (I/O) layer 670 and physical memory layer 680.

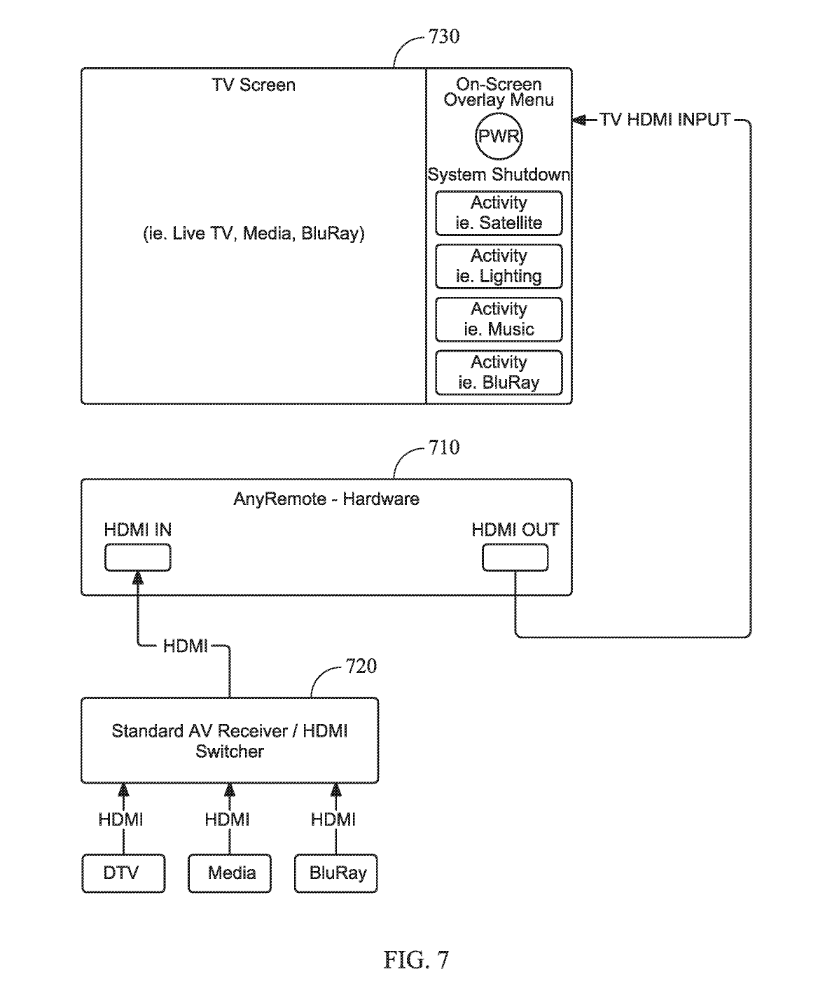

FIG. 7 shows an apparatus for translating functions and displaying content utilizing HDMI signals, in accordance with one or more embodiments. Logic circuitry 710 includes respective HDMI input and output ports as shown, and is configured for presenting input HDMI signals to a display 730, such as a TV screen, and for displaying a menu for operating endpoint devices in accordance with one or more embodiments herein. By way of example, an HDMI switcher 720 can be used to switch multiple HDMI inputs, such as from a satellite, media player or optical disc player. Menus such as those generated in accordance with various embodiments herein, including those characterized in other figures, can be presented on the display 730. In some embodiments, informational content or menu systems are overlaid on content from an A/V source.

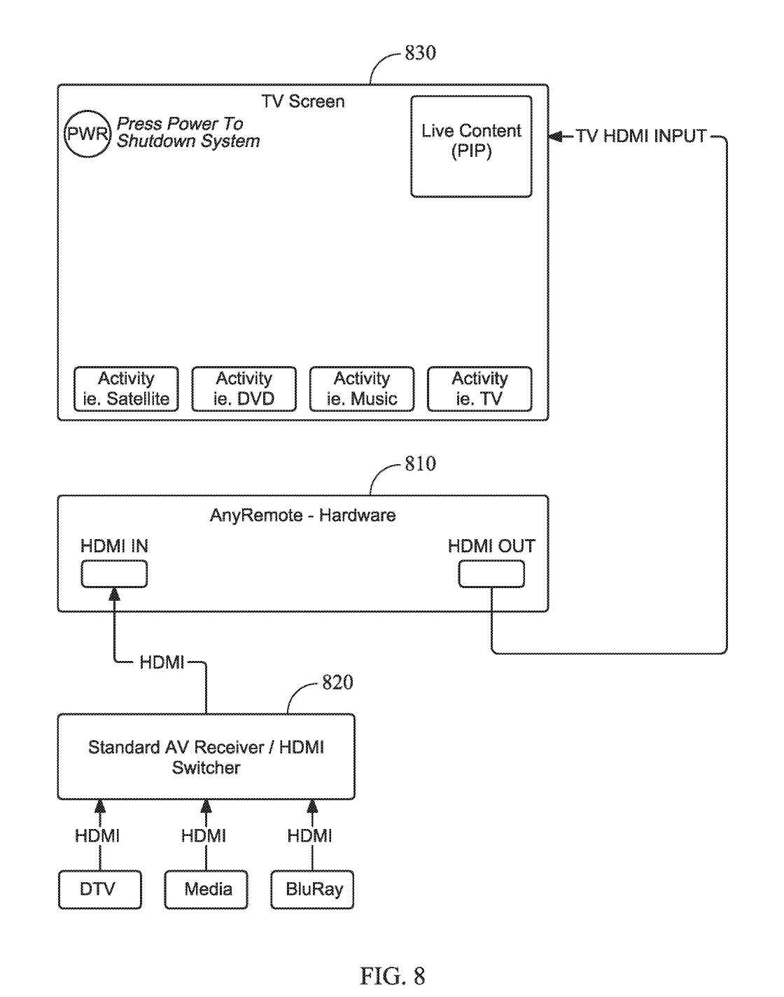

FIG. 8 shows another apparatus for translating functions and displaying menu content utilizing HDMI signals, in accordance with one or more embodiments. Similar to FIG. 7, logic circuitry 810 an HDMI switcher 820, and display 830 can be used to display information along with current content being presented in accordance with a selected function/activity. Live content can be displayed as a picture-in-picture (PIP) region of the display 830, with other menu functions displayed in a main region of the display.

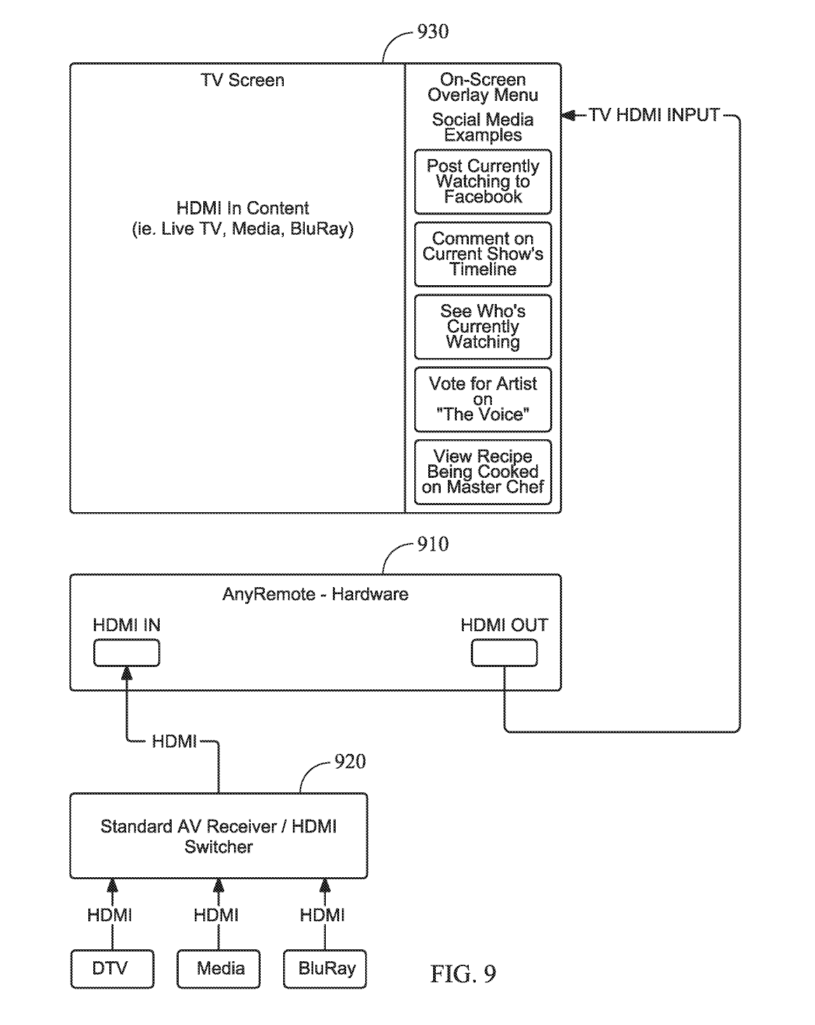

FIG. 9 shows another apparatus for translating functions and displaying menu content utilizing HDMI signals, in accordance with one or more embodiments. Similar to FIGS. 7 and 8, logic circuitry 910, HDMI switcher 920, and display 930 can be used to display information along with current content being presented in accordance with a selected function/activity. By way of example, social media functions are shown along with current content such as live television being displayed. The menu items may be selected and executed accordingly, such as to comment, post, share, and like the current content being displayed. In certain embodiments, online shopping services are displayed and utilized for purchasing items from the menu using a remote.

Various blocks, modules or other circuits may be implemented to carry out one or more of the operations and activities described herein and/or shown in the figures. In these contexts, a “block” (also sometimes “logic circuitry” or “module”) is a circuit that carries out one or more of these or related operations/activities (e.g., identify function, map functions, or run macro). For example, in certain of the above-discussed embodiments, one or more modules are discrete logic circuits or programmable logic circuits configured and arranged for implementing these operations/activities, as in the circuit modules shown in FIG. 1. In certain embodiments, such a programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions and the second module includes a second CPU hardware circuit with another set of instructions.

Certain embodiments are directed to a computer program product (e.g., nonvolatile memory device), which includes a machine or computer-readable medium having stored thereon instructions which may be executed by a computer (or other electronic device) to perform these operations/activities.

Based upon the above discussion and illustrations, those skilled in the art will readily recognize that various modifications and changes may be made to the various embodiments without strictly following the exemplary embodiments and applications illustrated and described herein. For example, various manners may be utilized to identify a type of command intended to be effected by an incoming signal, or a variety of manners for translation may be implemented to suite disparate systems, beyond those exemplified (e.g., control systems for marine, automotive, manufacturing and other environments). Such modifications do not depart from the true spirit and scope of various aspects of the invention, including aspects set forth in the claims.

1. An apparatus comprising:
communication circuitry configured and arranged for receiving wireless communications from a plurality of disparate remote input devices that respectively provide wireless communications including disparate control commands that are specific to each remote input device;
logic circuitry configured and arranged to identify a plurality of endpoint devices to be operated for carrying out an operation specified via each of the disparate control commands, and to translate the disparate control commands received from different ones of the remote input devices into output control commands for operating the plurality of endpoint devices for carrying out the operation by, for each received control command:
identifying the endpoint devices to be controlled with the received control command; and
selectively translating the received control command into output control commands for respectively controlling the identified endpoint devices; and
output circuitry configured and arranged to control the endpoint devices for carrying out an operation specified via the received control command by communicating the output control command to the endpoint devices.

2. The apparatus of claim 1, wherein the logic circuitry is configured and arranged to:
in response to the received control command being a command that the identified endpoint device is configured to operate in response to, operate in a device mode and provide the received control command as the output control command; and
in response to the received control command being a command that the identified endpoint device is not configured to operate in response to, operate in a hub mode and translating the received control command into the output command, the output command being different than the received control command and configured for controlling the identified endpoint device to carry out the specified operation.

3. The apparatus of claim 1, wherein the logic circuitry is configured and arranged to selectively translate the received control command into the output control command by:
identifying an operation intended to be effected via the control command, based on data in the received control command;
based on the identified operation intended to be effected, selecting a different control command that is operable for controlling the identified endpoint device to carry out the identified operation; and
providing the selected control command as the output control command.

4. The apparatus of claim 3, wherein the logic circuitry is configured and arranged to identify the operation intended to be effected via the control command by identifying the type of the remote input device transmitting the received control signal, and retrieving stored data characterizing operations associated with known control commands communicated by the identified type of the remote input device.

5. The apparatus of claim 1, wherein the logic circuitry is configured and arranged to:
determine whether the identified endpoint device is configured to operate in response to the received control command; and
in response to the identified endpoint device being configured to operate in response to the received control command, providing the received control command as the output control command.

6. The apparatus of claim 5, wherein the logic circuitry is configured and arranged to match the received control command to one of a plurality of endpoint devices available for control via the output circuitry, and to output the received control command to the matched one of the plurality of endpoint devices.

7. The apparatus of claim 1, wherein the logic circuitry is configured and arranged to determine whether the identified endpoint device is configured to operate in response to the received control command, and in response to the identified endpoint device being configured to operate in response to each of the received control commands:
identify an ancillary endpoint device to be used with the identified endpoint device for a particular activity,
identify a control command for the ancillary endpoint device for controlling the ancillary endpoint device for operating in conjunction with the identified endpoint device for carrying out the operation, and
transmit the identified control command to the ancillary endpoint device.

8. The apparatus of claim 1, wherein the logic circuitry is configured and arranged to
translate the received control command into multiple output control commands that respectively set different ones of the plurality of endpoint devices into a common mode for carrying out an operation, and
in response to receiving a different type of control command from a different one of the remote input devices, selectively translate the received control command into a plurality of output control commands for controlling the identified endpoint devices, based on characteristics of the common mode, the operation specified via the received control command and the identified endpoint device.

9. The apparatus of claim 8, wherein the logic circuitry is configured and arranged to identify the endpoint device to be controlled with the received control command in response to a user input received from the remote input device providing the received control command map functions associated with the common mode to different ones of the remote control devices, and to carry out common functions using different commands from each of the different ones of the remote control devices based on the mapping, by outputting the same respective mapped functions having a protocol for controlling ones of the endpoint devices in the common mode in response to receiving different commands from the different ones of the remote control devices.

10. The apparatus of claim 1, wherein the logic circuitry is configured and arranged to:
respond to a common command type received from any of the plurality of disparate types of remote input devices by entering into a device selection mode; and
in the device selection mode, identify the endpoint device to be controlled in response to a further input from one of the plurality of disparate types of remote input devices.

11. The apparatus of claim 10, wherein the common command type is a power-related command for powering an endpoint device.

12. The apparatus of claim 1, wherein the logic circuitry is configured and arranged to identify the operation specified via the received control command by comparing the received control command with stored commands, and identifying the operation based on stored data that associates one of the stored commands that matches the received control command, with an operation.

13. The apparatus of claim 12, further including storage circuitry configured and arranged to store a plurality of operations, and to associate each stored operation with multiple ones of the stored commands that respectively correspond to control commands for disparate ones of the remote input devices.

14. The apparatus of claim 1, wherein the logic circuitry is configured and arranged to identify the endpoint device to be controlled based on data indicative of endpoint devices available for control by the output circuitry, and characteristics of the received control command.

15. The apparatus of claim 1, wherein the logic circuitry is configured and arranged to identify the endpoint device to be controlled by selecting one of at least two endpoint devices available for control via the output circuitry, based upon a location at which the control command is received and respective locations of the at least two endpoint devices.

16. The apparatus of claim 1, wherein the logic circuitry is configured and arranged to identify the endpoint device to be controlled based on communications received from one or more endpoint devices communicatively coupled to the logic circuitry.

17. The apparatus of claim 1, wherein the logic circuitry is configured and arranged with the communication circuitry to, in response to receiving another wireless command from a second one of the remote input devices after identifying the plurality of endpoint devices to be operated for carrying out an operation specified via one of the disparate control commands from a first one of the remote input devices, translate the other wireless command received from the second one of the remote input devices for operating the plurality of endpoint devices identified in response to the wireless command received from the first one of the remote input devices.

18. The apparatus of claim 1, wherein the logic circuitry is configured and arranged to discover endpoint devices available for being controlled by the output circuitry, by sending a polling signal operative to control the endpoint devices to communicate identification data to the logic circuitry in response to the polling, the identification data for each endpoint device being indicative of the type of the endpoint device.

19. The apparatus of claim 1, wherein the logic circuitry is configured and arranged to identify the endpoint device to be controlled based on identification information transmitted by the remote input device with the control command.

20. A method comprising:
receiving wireless communications from a plurality of disparate remote input devices, the wireless communications including disparate control commands that are specific to each remote input device;
translating the disparate control commands received from different ones of the remote input devices into output control commands by:
identifying endpoint devices to be controlled with the received control command for operating the endpoint devices to carry out an operation; and
selectively translating the received control command into output control commands for controlling the identified endpoint devices to carry out the operation; and
controlling the endpoint devices for carrying out an operation specified via the received control command by communicating the output control command to the endpoint devices.
